(19) United States
(12) Patent Application Publication
(10) Pub. No.: US 2019/0141905 A1
(43) Pub. Date: May 16, 2019

(54) Hydroponic Cultivation System, Hydroponic Cultivation Control Apparatus, Hydroponic Cultivation Method, and Program

(71) Applicant: Toyo Seikan Group Holdings, Ltd., Tokyo (JP)

(72) Inventors: JUN AGARI, Tokyo (JP); MARI NISHI, Kudamatsu-shi, Yamaguchi (JP); AKANE ITO, Kudamatsu-shi, Yamaguchi (JP); YASUHIRO DOMOTO, Kudamatsu-shi, Yamaguchi (JP); KATSUYA MIYAKE, Kudamatsu-shi, Yamaguchi (JP); KIYOSHI IWATANI, Yamaguchi-shi, Yamaguchi (JP)

(21) Appl. No.: 16/301,876

(22) PCT Filed: May 1, 2017
(86) PCT No.: PCT/JP2017/017199

§ 371 Date: Nov. 15, 2018

(30) Foreign Application Priority Data
May 30, 2016 (JP) 2016-107242

(51) Int. Cl. A01G 7/04; A01G 31/06; H05B 33/08; H05B 37/02

(52) U.S. Cl. CPC A01G 7/045; H05B 37/0218; H05B 33/0854; A01G 31/06

(57) ABSTRACT

[Object] To suppress the variations in the growth of cultivation products to perform stable production, and reduce the power cost for applying artificial light.

[Solving Means] A hydroponic cultivation system includes a hydroponic cultivation unit, a daylighting apparatus, an artificial light application apparatus, a daylighting sensor, and a control apparatus. The hydroponic cultivation unit includes a seedbed, a seedling of a plant to be cultivated being transplanted to the seedbed. The daylighting apparatus takes natural light through a daylighting port into a light emitting surface facing the seedbed, and emits the light from the light emitting surface toward the seedling. The artificial light application apparatus applies artificial light to the seedling. The daylighting sensor is provided at a position apart from the seedbed, and detects a light amount of the natural light emitted from the light emitting surface. The control apparatus calculates, on a basis of the detected light amount, a predicted value of a light amount of the natural light applied to a cultivation surface of the seedling in the seedbed, and controls, on a basis of the predicted value, an application amount of the artificial light.

### TECHNICAL FIELD

The present invention relates to a hydroponic cultivation system combining natural light taken by a daylighting apparatus and artificial light, and to a hydroponic cultivation control apparatus, a hydroponic cultivation method, and a program that are used in the hydroponic cultivation system.

### BACKGROUND ART

In the past, a hydroponic cultivation system for cultivating plants such as vegetables indoors using hydroponic cultivation has been put to practical use. In such a hydroponic cultivation system, there are a cultivation method that uses only artificial light and a cultivation method that combines natural light (sunlight) and artificial light.

Regarding the latter, the following Patent Literature 1 discloses a plant factory in which a plurality of stages of plant cultivation racks each including a nutrient solution circulation means are provided in a growth room that is a closed space in a plant cultivation house, an artificial light source such as a lamp and an LED is provided above the plant cultivation racks, and sunlight is collected by a daylighting apparatus provided above the roof of the plant cultivation house and applied to the plant cultivation racks by a plurality of reflection mirrors.

### CITATION LIST

### Patent Literature

Patent Literature 1: Japanese Patent Application Laid-open No. 2012-231721

### DISCLOSURE OF INVENTION

### Technical Problem

However, with the technology described in the above-mentioned Patent Literature 1, since the intensity of sunlight taken by the daylighting apparatus differs depending on the weather, variations occur in the growth of cultivation products.

Meanwhile, more than necessary light supplement by artificial light does not contribute to the growth of cultivation products and power is wasted.

In view of the circumstances as described above, it is an object of the present invention to provide a hydroponic cultivation system, a hydroponic cultivation control apparatus, a hydroponic cultivation method, and a program that are capable of suppressing the variations in the growth of cultivation products, thereby to perform stable production, and reducing the power cost for applying artificial light.

### Solution to Problem

In order to achieve the above-mentioned object, a hydroponic cultivation system according to an embodiment of the present invention includes a hydroponic cultivation unit, a daylighting apparatus, an artificial light application apparatus, a daylighting sensor, and a control apparatus. The hydroponic cultivation unit includes a seedbed, a seedling of a plant to be cultivated being transplanted to the seedbed. The daylighting apparatus takes natural light through a daylighting port into a light emitting surface facing the seedbed, and emits the light from the light emitting surface toward the seedling. The artificial light application apparatus applies artificial light to the seedling. The daylighting sensor is provided at a position apart from the seedbed, and detects a light amount of the natural light emitted from the light emitting surface. The control apparatus calculates, on a basis of the detected light amount, a predicted value of a light amount of the natural light to be applied to a cultivation surface of the seedling in the seedbed, and controls, on a basis of the predicted value, an application amount of the artificial light.

Accordingly, the cultivation system is capable of suppressing the variations in the growth of cultivation products in the case of performing cultivation with only natural light, thereby to perform stable production by controlling, on the basis of the predicted value of the light amount of natural light to be applied to the cultivation surface, the application amount of artificial light, and reducing the power cost for applying artificial light by applying, as necessary, artificial light.

The control apparatus may control the application amount of the artificial light of a predetermined time period so that a sum of the application amount of the artificial light and an accumulated value of the predicted value of the predetermined time period reaches a predetermined target instantaneous light amount (instantaneous value: unit of μmol/m2·s).

Accordingly, the hydroponic cultivation system is capable of more stably producing cultivation products by setting a target instantaneous light amount. The predetermined time period may be, for example, one hour or one day.

The daylighting sensor may be provided on the light emitting surface.

Accordingly, by providing the daylighting sensor on the light emitting surface from which natural light is soon applied to the cultivation surface, the hydroponic cultivation system is capable of more accurately predicting the light amount of the cultivation surface as compared with the case where the daylighting sensor is provided outdoors or the like.

The artificial light application apparatus may be provided on the light emitting surface. In this case, the daylighting sensor may be provided at a position where the daylighting sensor is not affected by the artificial light of the light emitting surface.

Accordingly, the hydroponic cultivation system is capable of detecting the light amount of natural light of the light emitting surface without being affected by artificial light even during application of the artificial light, and predicting the light amount of the cultivation surface.

The seedbed may include seedbeds provided to face each other in a horizontal direction with a pair of light emitting surfaces disposed between the seedbeds, the pair of light emitting surfaces being provided opposite to each other in the horizontal direction. In this case, the daylighting sensor may be capable of detecting, at a time when the natural light is not applied, a light amount of reflected light of artificial light applied, to the seedling, from the artificial light application apparatus provided on the light emitting surface different from the light emitting surface on which the same daylighting sensor is provided. Further, in this case, the control apparatus may control the application amount of the artificial light on a basis of a change in the detected light amount of reflected light.

In general, when a seedling grows and the leaf area is increased, the reflectance is reduced because the leaves absorb light. Therefore, by detecting, with the daylighting sensor, not only the light amount of natural light to be applied from the light emitting surface but also the change in reflected light of the artificial light applied to the seedling from a light emitting surface opposite to the light emitting surface, the hydroponic cultivation system is capable of managing the growth of the seedling by grasping the growth degree of the seedling and controlling the application amount of artificial light accordingly.

Further, also the reflectance of the seedbed and the reflectance of leaves are related to the growth degree of the seedling. In general, in the case where the reflectance of the seedbed is higher than the reflectance of the leaves, the amount of light reflected from the seedbed is reduced as the leaves grow. In the case where the reflectance of the seedbed is lower, since the amount of light reflected from the leaves is increased as the leaves grow, the amount of reflected light detected by the daylighting sensor is increased.

Therefore, when the reflected light in the case where the target leaf area has been achieved is used as a reference, a numerical value higher than that of the reference reflected light is detected because the amount of light reflected from the seedbed is increased when the growth of the leaves is delayed, in the case where the reflectance of the seedbed is higher than the reflectance of the leaves.

Further, in the case where the reflectance of the seedbed is lower than the reflectance of the leaves, a numerical value lower than that of the reference reflected light is detected because the amount of light reflected from the leaves is decreased when the growth of the leaves is delayed.

As described above, considering the reflectance, an error between the reflected light detected by the daylighting sensor and the reference reflected light in the case where the target leaf area has been achieved can be determined to manage the growth of the leaves.

The hydroponic cultivation system may further include an outdoor light sensor that detects a light amount of outdoor natural light. In this case, the control apparatus may output information representing abnormality in a case where it is determined that there is no correlation between a change in a light amount of natural light detected by the daylighting sensor and a change in a light amount of natural light detected by the outdoor light sensor.

Accordingly, the hydroponic cultivation system is capable of improving the precision of the application amount control by outputting abnormality information in the case where it is detected that the amount of light of the light emitting surface, which is normally correlated with the amount of outdoor light, is not correlated with the amount of outdoor light. Here, as a cause for losing the correlation between the above-mentioned changes, for example, a situation in which the daylighting sensor is irradiated with direct light or hidden behind the seedling or human to reduce the taken light amount is assumed.

A hydroponic cultivation system according to another embodiment of the present invention includes a hydroponic cultivation unit, a daylighting apparatus, an artificial light application apparatus, and a daylighting sensor. The hydroponic cultivation unit includes a seedbed, a seedling of a plant to be cultivated being transplanted to the seedbed. The daylighting apparatus takes natural light through a daylighting port into a light emitting surface facing the seedbed, and emits the light from the light emitting surface toward the seedling. The artificial light application apparatus applies artificial light to the seedling. The daylighting sensor is provided at a position where the daylighting sensor is not affected by the artificial light of the light emitting surface, and detects, for controlling an application amount of the artificial light, a light amount of the natural light emitted from the light emitting surface.

A hydroponic cultivation control apparatus according to still another embodiment of the present invention includes a reception unit and a control apparatus. The reception unit receives, from a daylighting sensor provided at a position apart from a seedbed, a detection value of a light amount of natural light taken through a daylighting port into a light emitting surface facing the seedbed, the natural light being emitted from the light emitting surface, a seedling of a plant to be cultivated being transplanted to the seedbed. The control apparatus calculates, on a basis of the received detection value, a predicted value of a light amount of the natural light to be applied to a cultivation surface of the seedling in the seedbed, and controls, on a basis of the predicted value, an application amount of the artificial light to be applied to the seedling.

A hydroponic cultivation method according to still another embodiment of the present invention includes:

placing a seedbed in a hydroponic cultivation unit, a seedling of a plant to be cultivated being transplanted to the seedbed;

taking natural light from outside into a light emitting surface facing the seedbed, and applying the light from the light emitting surface toward the seedling;

calculating, on a basis of a light amount of the natural light to be output from the light emitting surface, which is detected by a daylighting sensor that is provided at a position apart from the seedbed, a predicted value of the light amount of the natural light to be applied to a cultivation surface of the seedling in the seedbed; and

controlling, on a basis of the predicted value, an application amount of the artificial light to be applied to the seedling.

A program according to still another embodiment of the present invention causes a hydroponic cultivation control apparatus to execute the steps of:

receiving, from a daylighting sensor provided at a position apart from a seedbed, a detection value of a light amount of natural light taken through a daylighting port into a light emitting surface facing the seedbed, the natural light being emitted from the light emitting surface, a seedling of a plant to be cultivated being transplanted to the seedbed;

calculating, on a basis of the received detection value, a predicted value of a light amount of the natural light to be applied to a cultivation surface of the seedling in the seedbed; and

controlling, on a basis of the predicted value, an application amount of the artificial light to be applied to the seedling.

### Advantageous Effects of Invention

As described above, according to the present invention, it is possible to suppress the variations in the growth of cultivation products to perform stable production, and reduce the power cost for applying artificial light. However, these effects do not limit the present invention.

### BRIEF DESCRIPTION OF DRAWINGS

FIG. 1 is a diagram showing a configuration of a hydroponic cultivation system according to an embodiment of the present invention.

FIG. 2 is a diagram showing a hardware configuration of a control apparatus of the hydroponic cultivation system according to the embodiment of the present invention.

FIG. 3 is a flowchart showing flow of a schematic operation of the hydroponic cultivation system according to the embodiment of the present invention.

FIG. 4 is a graph showing a relationship between the light amount of a cultivation surface and the light amount of a light emitting surface in the hydroponic cultivation system according to the embodiment of the present invention.

FIG. 5 is a graph showing a relationship between the supplemental light amount and the light amount of the light emitting surface in the hydroponic cultivation system according to the embodiment of the present invention.

FIG. 6 is a graph showing a relationship between the output of an LED and the supplemental light amount in the hydroponic cultivation system according to the embodiment of the present invention.

FIG. 7 is a diagram describing a specific example of light adjusting control processing of the LED by the hydroponic cultivation system according to the embodiment of the present invention.

FIG. 8 is a diagram describing management of the accumulated light amount necessary for the light adjusting control processing of the LED by the hydroponic cultivation system according to the embodiment of the present invention.

FIG. 9 is a flowchart describing flow of the light adjusting control processing of the LED by the hydroponic cultivation system according to the embodiment of the present invention.

FIG. 10 is a diagram showing a relationship between one hour control and one day control in the light adjusting control processing of the LED by the hydroponic cultivation system according to the embodiment of the present invention.

FIG. 11 is a flowchart showing more detailed flow of the light adjusting control processing of the LED by the hydroponic cultivation system according to the embodiment of the present invention.

FIG. 12 is a table showing a one day result of performing the light adjusting control processing of the LED by the hydroponic cultivation system according to the embodiment of the present invention.

FIG. 13 is a graph showing the one day result of performing the light adjusting control processing of the LED by the hydroponic cultivation system according to the embodiment of the present invention.

FIG. 14 is a diagram showing a relationship between the light amount and the number of cultivation days of the cultivation surface and the light emitting surface in the hydroponic cultivation system according to the embodiment of the present invention.

FIG. 15 is a flowchart showing flow of growth management processing using the amount of reflected light of leaves by the hydroponic cultivation system according to the embodiment of the present invention.

### MODE(S) FOR CARRYING OUT THE INVENTION

Hereinafter, embodiments of the present invention will be described with reference to the drawings.

[Configuration of System]

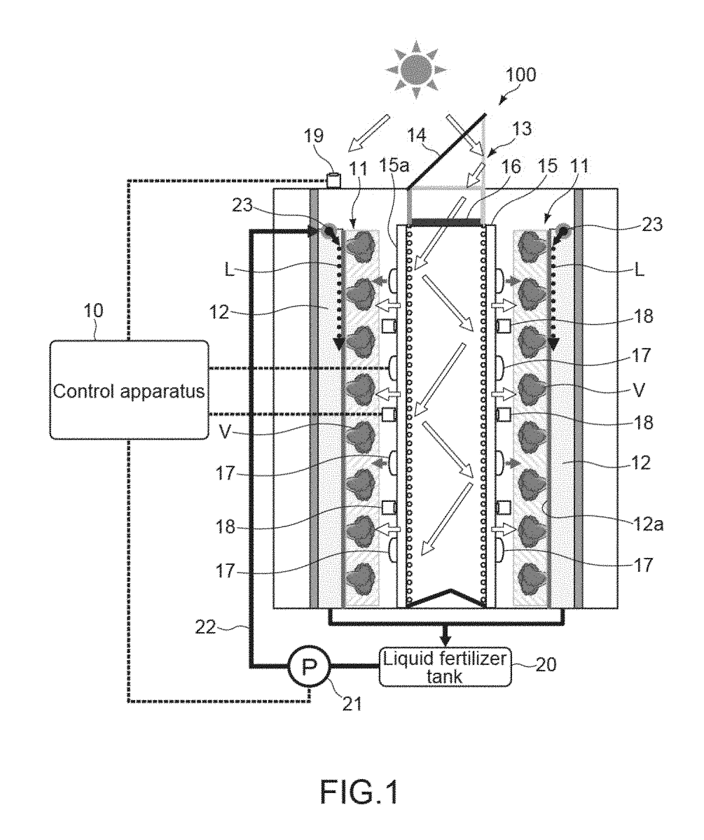

FIG. 1 is a diagram showing a configuration of a hydroponic cultivation system according to this embodiment.

This hydroponic cultivation system is a system for cultivating plants such as leafy vegetables including lettuce, green leaf, Boston lettuce, mizuna (Japanese mustard greens), spinach, and herbs.

As shown in the figure, a hydroponic cultivation system 100 includes a control apparatus 10, hydroponic cultivation units 11, and a daylighting apparatus 13, and they are provided in a plant factory.

The hydroponic cultivation unit 11 each include a cultivation panel 12 to which seedlings V of the above-mentioned leafy vegetable to be cultivated, which are grown from seeds in a seedbed, are transplanted. Each of the cultivation panels 12 is placed vertically (in the vertical direction) in the hydroponic cultivation unit 11. The cultivation panel 12 is an example of the seedbed to which a seedling is transplanted. The seedbed may have, for example, a tubular shape other than a panel shape such as that of the cultivation panel 12.

As the cultivation panel 12, for example, a board (including a foam board) formed of synthetic resin such as polystyrene, polypropylene, polyethylene, and polyurethane, a fiber board formed of a fiber material such as vegetable fiber, resin fiber, and inorganic fiber, wood or the like is used. However, the cultivation panel 12 is not particularly limited as long as it is lightweight and has strength enough to withstand the weight of the grown seedlings V.

The shape of the cultivation panel 12 is not particularly limited, and may be any shape such as a plate shape, a column shape, a cylinder shape, a rice paddy shape, and an inclined shape as long as it is capable of holding a seedling of a plant.

A plurality of planting holes (not shown) for holding the transplanted seedlings V are drilled in the cultivation panel 12, and the planting holes are arranged at appropriate intervals considering the size of each seedling V in the harvest season.

One surface of the cultivation panel 12 is a cultivation surface 12a, and the other surface thereof is a liquid fertilizer supply surface. A liquid fertilizer (liquid fertilizer obtained by dissolving solid or liquid fertilizer in water) L is supplied from a liquid fertilizer tank 20 to a liquid fertilizer supply port 23 via a liquid fertilizer supply pipe 22 by a pump 21, and distributed to the root of the seedling V from the liquid fertilizer supply port 23 through the liquid fertilizer supply surface.

The daylighting apparatus 13 only needs to have a structure capable of taking natural light (sunlight), and a light duct, a skylight, or the like is used. The daylighting apparatus 13 may include a solar tracking device, a louver, and the like. For example, in the case where the daylighting apparatus 13 includes a light duct, a daylighting port 14 for taking natural light (sunlight), a pair of acrylic plates 15 facing with each other in the horizontal direction, and a diffusion plate 16 provided between the daylighting port 14 and the acrylic plates 15 are provided.

The material of the acrylic plates 15 is not limited to acrylic as long as it is a transparent material such as polycarbonate and vinyl. Further, the shape of each of the acrylic plates 15 is not limited to a plate shape, and may be any of various shapes such as a film shape. It is favorable to provide this transparent partition such as an acrylic plate in order to improve the air conditioning efficiency of the cultivation space. However, it does not necessarily need to provide the transparent partition considering the workability and cost.

The sunlight taken from the daylighting port 14 is diffused by the diffusion plate 16, emitted (output) from the outer surfaces (light emitting surfaces 15a) of the acrylic plates 15 while being repeatedly reflected between the acrylic plates 15, and irradiated onto the seedling V of the cultivation panel 12. The light emitting surfaces 15a of the pair of acrylic plates 15 are provided in opposite directions in the horizontal direction.

Further, the cultivation panels 12 are provided opposite to each other in the horizontal direction with the ground with the pair of acrylic plates 15 disposed therebetween.

On the light emitting surface 15a of each of the acrylic plates 15, LEDs 17 as artificial light application apparatuses for applying artificial light to the seedling V are provided. Each of the LEDs is responsible for supplementing sunlight in the case where light applied to the seedling V does not reach a predetermined target value only with the sunlight.

The light supplement by the LED 17 is performed not only in parallel with application of sunlight from the light emitting surface 15a by the daylighting apparatus 13 but also in the nighttime when sunlight is not applied.

Similarly, on the light emitting surface 15a of each of the acrylic plates 15, daylighting sensors 18 that detect the light amount of sunlight output from the light emitting surface 15a are provided. Each of the daylighting sensors 18 is located at a position apart from the cultivation panel, which is not affected by artificial light applied from the LED 17 provided on the same light emitting surface 15a, e.g., a position where a light reception unit of the daylighting sensor 18 faces the side of the acrylic plate 15 and does not receive artificial light applied from the LED 17 provided on the same light emitting surface 15a.

Further, an outdoor light sensor 19 that detects the light amount of outdoor natural light (sunlight) is provided outside the hydroponic cultivation unit 11.

The control apparatus 10 is connected to the LED 17 and the daylighting sensor 18. The control apparatus 10 receives the light amount of sunlight on the light emitting surface 15a detected by the daylighting sensor 18, and calculates, on the basis of the detected light amount of sunlight, a predicted value of the light amount of sunlight to be applied to the cultivation surface 12a of the seedling V in the cultivation panel 12. Further, the control apparatus 10 is capable of controlling, on the basis of the predicted value, the application amount of artificial light to be applied from the LED 17 (hereinafter, this control is referred to also as light adjusting control processing). Specifically, the control apparatus 10 controls the application amount of artificial light from the LED 17 of a predetermined time period (one hour, one day, or the like) so that the sum of the application amount and the accumulated value of the predicted value of the light amount of the cultivation surface 12a reaches a predetermined target instantaneous light amount of the predetermined time period. Details of the light adjusting control processing will be described later.

Further, the control apparatus 10 is connected also to the pump 21, and controls supply of a liquid fertilizer and the supply amount thereof. Further, the control apparatus 10 is connected also to the outdoor light sensor 19, and receives the light amount of outdoor light detected by the outdoor light sensor 19.

As will be described later in detail, the control apparatus 10 is capable of comparing the change in the light amount of sunlight detected by the daylighting sensor 18 and the change in the light amount of sunlight detected by the outdoor light sensor 19 to output, in the case where it is determined that there is no correlation between them, information representing abnormality.

Further, the daylighting sensor 18 is capable of detecting, at the time when the natural light is not applied (e.g., nighttime or rainy weather), the light amount of reflected light of artificial light applied to the seedling V from the LED 17 provided on the light emitting surface 15a of the other acrylic plate 15 opposite to the acrylic plate 15 on which the same daylighting sensor 18 is provided.

Further, as will be described later in detail, the control apparatus 10 is capable of grasping, on the basis of the change in the detected light amount of reflected light, the growth degree of the seedling V, and controlling the application amount of artificial light to be applied from the LED 17 accordingly.

[Hardware Configuration of Control Apparatus]

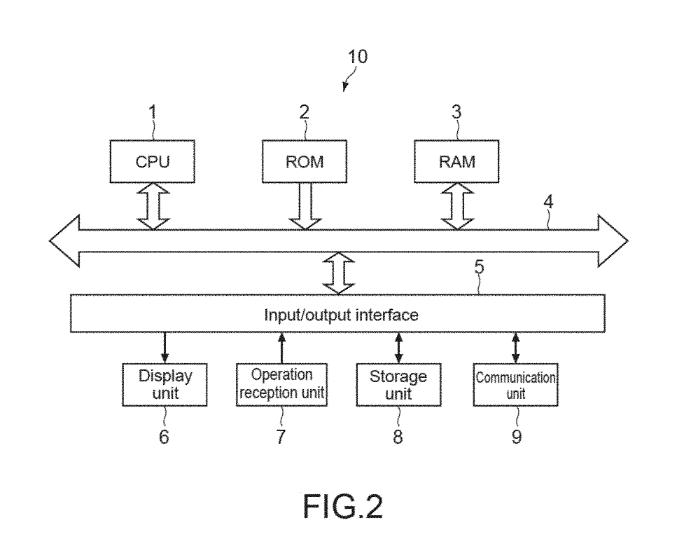

FIG. 2 is a diagram showing a hardware configuration of the control apparatus 10. As shown in the figure, the control apparatus 10 includes a CPU (Central Processing Unit) 1, a ROM (Read Only Memory) 2, a RAM (Random Access Memory) 3, an input/output interface 5, and a bus 4 connecting them to each other.

The CPU 1 appropriately accesses the RAM 3 or the like, and integrally control the entire blocks of the control apparatus 10 while performing various kinds of arithmetic processing. The ROM 2 is a non-volatile memory in which an OS to be executed by the CPU 1 and firmware such as a program and various parameters are statically stored. The RAM 3 is used as, for example, a work area of the CPU 1, and temporarily stores the OS, various applications being executed, and various types of data being processed.

To the input/output interface 5, a display unit 6, an operation reception unit 7, a storage unit 8, a communication unit 9, and the like are connected.

The display unit 6 is a display device using, for example, an LCD (Liquid Crystal Display), an OELD (Organic Electro Luminescence Display), and a CRT (Cathode Ray Tube). On the display unit 6, for example, a control screen of the detected value by the daylighting sensor 18 or outdoor light sensor 19, the output value by the LED 17, or the like may be displayed.

The operation reception unit 7 is, for example, a pointing device such as a mouse, a keyboard, a touch panel, or another input device. In the case where the operation reception unit 7 is a touch panel, the touch panel may be integrated with the display unit 6.

The storage unit 8 is a non-volatile memory such as a flash memory including an HDD (Hard Disk Drive) and an SSD (Solid State Drive). In the storage unit 8, a software program necessary for the light adjusting control processing in this embodiment and data in addition to the OS, the various applications, and the various types of data are stored.

The data stored in the storage unit 8 includes data of the light amount of the light emitting surface detected by the daylighting sensor 18, the amount of outdoor light detected by the outdoor light sensor 19, the accumulated light amount of the detected light amount of the light emitting surface in a predetermined time period (e.g., one hour and one day), the light amount (predicted value) of the cultivation surface calculated on the basis of the light amount of the light emitting surface, the target value of the light amount of the cultivation surface, the difference value between the target value and the light amount of the cultivation surface, the value of daily usage power, and the like.

The communication unit 9 is, for example, one of various modules for wireless communication such as a NIC (Network Interface Card) for Ethernet and a wireless LAN, and used for communication with the LED 17, the daylighting sensor 18, and the outdoor light sensor 19.

[Operation of Hydroponic Cultivation System]

Next, the operation of the hydroponic cultivation system 100 configured as described above will be described. The operation is executed by cooperation of hardware such as the CPU 1 of the control apparatus 10, software stored in the storage unit 8, and the LED 17, the daylighting sensor 18, and the outdoor light sensor 19 connected to the control apparatus 10.

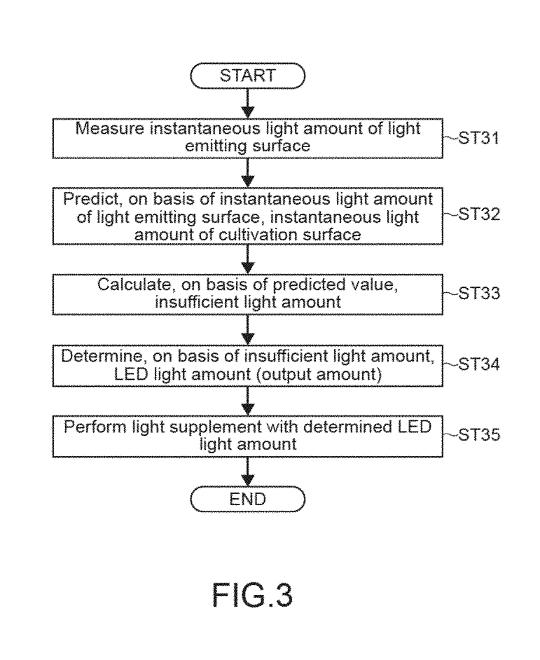

FIG. 3 is a flowchart showing schematic flow of the light adjusting control processing by the hydroponic cultivation system.

As shown in the figure, first, the daylighting sensor 18 measures the instantaneous light amount of the light emitting surface 15a (Step 31). The measured value is transmitted to the control apparatus 10 and stored in the storage unit 8.

Subsequently, the control apparatus 10 predicts, on the basis of the measured instantaneous light amount of the light emitting surface 15a, the instantaneous light amount of the cultivation surface 12a (Step 32). For the prediction processing, data (to be described later) representing the relationship between the instantaneous light amount of the cultivation surface 12a and the instantaneous light amount of the light emitting surface 15a is used.

Subsequently, the control apparatus 10 calculates the insufficient light amount (supplemental light amount) in the cultivation surface 12a by subtracting a predicted value (accumulated value) of the light amount of the cultivation surface 12a in a predetermined time period (one hour, one day, or the like) from the target value of the light amount of the cultivation surface 12a in the predetermined time period (Step 33).

Subsequently, the control apparatus 10 determines, on the basis of the insufficient light amount, the output amount the LED 17 necessary for applying light by the insufficient light amount (Step 34). For the determination, correlation data (to be described later) between the supplemental light amount by the LED 17 and the output of the LED 17 is used.

Further, the control apparatus 10 controls the LED 17 so as to apply artificial light (light supplement) to the seedling V according to the determined output value (Step 35) (light adjusting control processing).

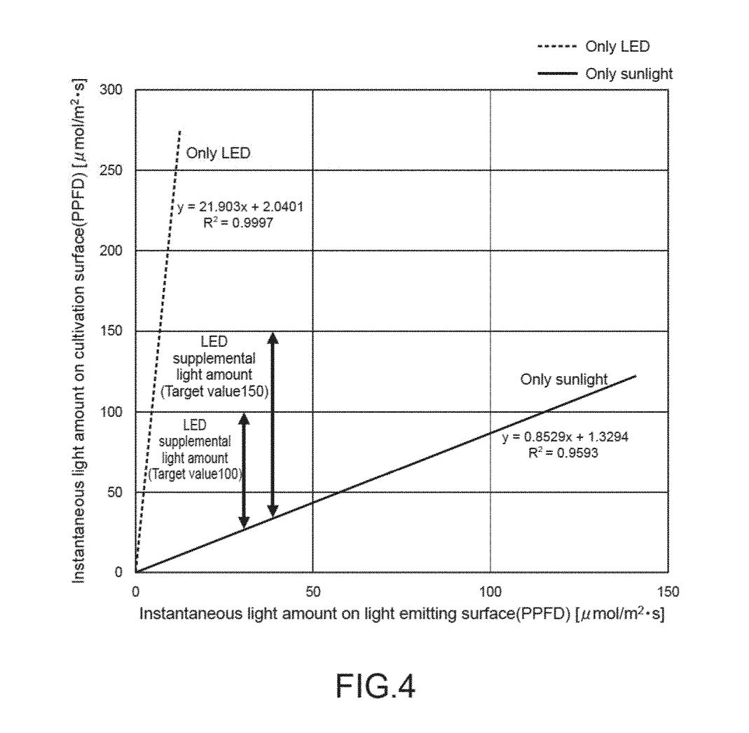

FIG. 4 is a graph showing the relationship between the instantaneous light amount of the cultivation surface 12a (PPFD) and the instantaneous light amount of the light emitting surface 15a (PPFD). In the figure, the instantaneous light amount (solid line in the figure) in the case where only sunlight taken by the daylighting apparatus 13 is applied to the seedling V and the instantaneous light amount (broken line in the figure) in the case where only artificial light of the LED 17 is applied to the seedling V are shown.

As shown in the figure, in the case where only sunlight is applied, the instantaneous light amount of the cultivation surface 12a is slightly smaller than the instantaneous light amount of the light emitting surface 15a. It is considered that this is because the light is attenuated by the amount corresponding to the distance between the light emitting surface 15a and the cultivation surface 12a.

Meanwhile, in the case where only artificial light of the LED 17 is applied, the instantaneous light amount of the cultivation surface 12a is significantly larger than the instantaneous light amount of the light emitting surface 15a. It is considered that this is because most of the light applied from the light emitting surface 15a by the LED 17 is repeatedly reflected by the cultivation panel 12 or the acrylic plate 15 and irradiated onto the cultivation surface 12a. Therefore, when the amount of reflected light from the cultivation panel 12 or the acrylic plate 15 is reduced as the leaves grow, the slope of the graph of the LED 17 is also reduced.

Further, as shown in the figure, in the case where the target value of the instantaneous light amount applied to the cultivation surface 12a is set to, for example, 100 or 150 (μmol/m2·s), the difference between the instantaneous light amount of the light emitting surface 15a and each target value is the supplemental light amount by the LED 17.

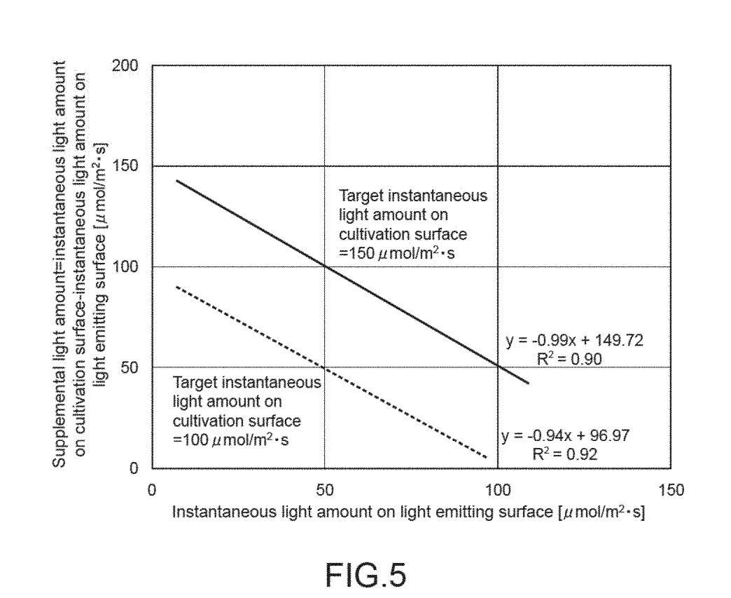

FIG. 5 is a graph showing the relationship between the supplemental light amount and the instantaneous light amount of the light emitting surface at the time of light adjusting control. As shown in the figure, at the light adjusting control, even in the case where the target value is set to, for example, any of 100 μmol/m2·s and 150 μmol/m2·s, the relationship between an instantaneous light amount X of the light emitting surface 15a and a supplemental light amount Y is represented by the equation of Y=X-target value.

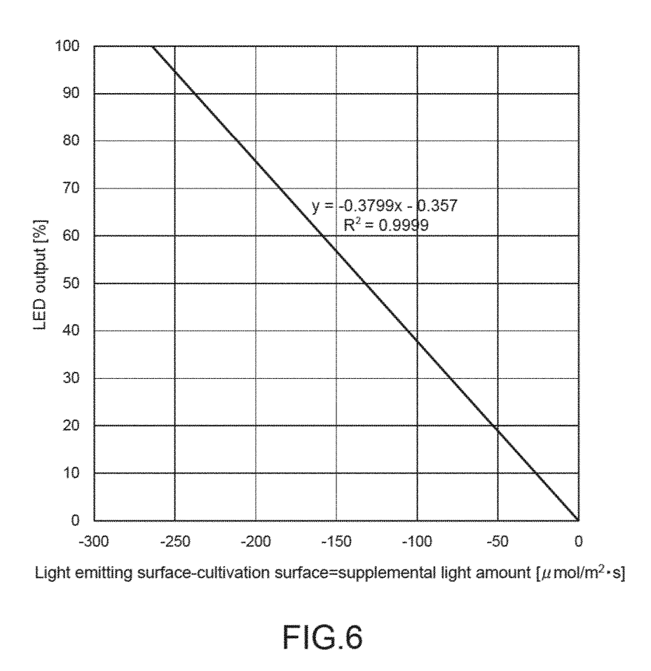

FIG. 6 is a graph showing the relationship between the output of the LED 17 and the supplemental light amount thereof. As shown in the figure, it can be seen that there is a proportional relationship between the supplemental light amount and output of the LED 17.

The control apparatus 10 stores data representing the relationships shown in FIG. 4 to FIG. 6 in the storage unit 8, and uses the data for conversion of the instantaneous light amount of the light emitting surface 15a into the instantaneous light amount (predicted value) of the cultivation surface 12a and determination of output of the LED 17 at the time of light supplement of the insufficient light amount by the LED 17.

[Specific Example of Light Adjusting Control Processing]

Examples of a specific method for the light adjusting control processing include the following four examples.

### (1) ON/OFF Control:

A threshold value is set for the amount of outdoor light. The LED 17 is turned ON in the case where the amount of outdoor light is less than the threshold value, and the LED 17 is turned OFF in the case where the amount of outdoor light is not less than the threshold value.

### (2) Target Value Control:

The output of the LED 17 is controlled between 0% to 100% so that the target light amount of the cultivation surface 12a always has the target value.

### (3) Accumulated Amount Control:

The shortage of the necessary accumulated light amount (target value) of one day is supplemented by the LED 17 at night, and the amount of light (excess amount) exceeding the target value out of the light amount of the one day is calculated as the light amount of the next day.

### (4) ON/OFF Control+Accumulated Amount Control:

A threshold value is set for the amount of outdoor light or a daylighting sensor installed on the light emitting surface. The LED 17 is turned ON in the case where the amount of light is less than the threshold value. In the case where the amount of light is not less than the threshold value, the LED 17 is turned OFF, and for each time zone in one day, the excess or deficiency of the light amount of the cultivation surface 12a with respect to the necessary accumulated amount (target value for each time zone) is corrected in the next time zone to control the accumulated light amount (target value of the one day) necessary for the one day.

In this embodiment, among these methods, the (4) ON/OFF control+accumulated amount control will be described.

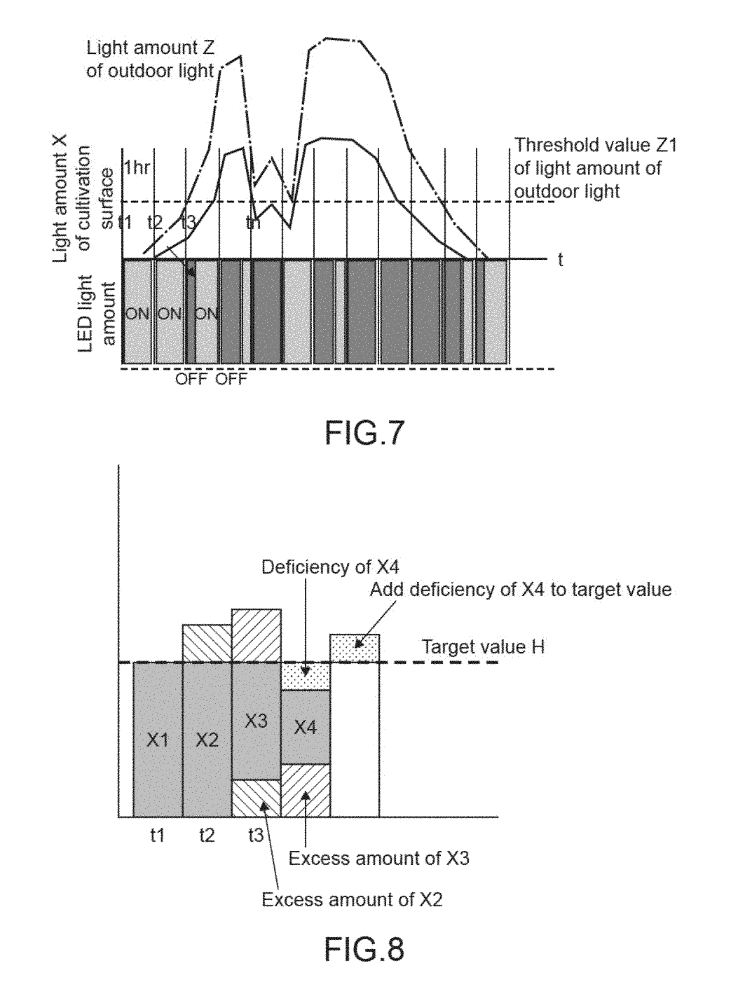

FIG. 7 and FIG. 8 are each a diagram conceptually showing the (4) ON/OFF control+accumulated amount control.

As shown in FIG. 7, in the case where a light amount Z of outdoor light detected by the daylighting sensor 18 is not less than a threshold value Z1 (t3 in the figure), the control apparatus 10 turns off /the LED 17.

The light amount Z of outdoor light may be a value detected by the outdoor light sensor 19.

Further, as shown in FIG. 8, in the case where the light amount of the cultivation surface 12a in a certain time zone exceeds a target value H (X2, X3), the control apparatus 10 adds the excess amount as the light amount of the cultivation surface 12a in the next time zone to monitor the excess or deficiency of the target value H.

Similarly, in the case where the light amount of the cultivation surface 12a in a certain time zone falls below the target value (X4), the control apparatus 10 adds the shortage to the target value H of the cultivation surface 12a in the next time zone to monitor the excess or deficiency of the target value H.

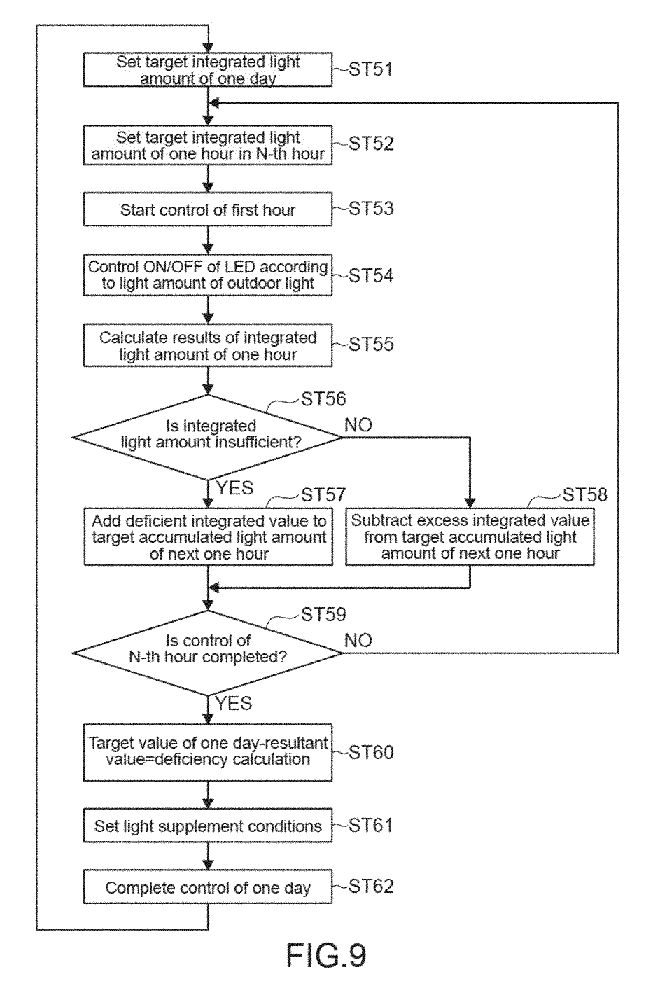

FIG. 9 is a flowchart describing flow of the light adjusting control processing by the ON/OFF control+accumulated amount control. In the following description, the (accumulated) light amount of the cultivation surface 12a represents the light amount predicted on the basis of the (accumulated) light amount of the light emitting surface 15a as described above.

As shown in the figure, the control apparatus 10 sets the target accumulated light amount of the cultivation surface 12a of one day first (Step 51).

Subsequently, the control apparatus 10 sets the target accumulated light amount of the cultivation surface 12a of the N-th hour (N is the irradiation time (hr) of sunlight in one day) (Step 52).

Subsequently, the control apparatus 10 starts control of the first hour (Step 53).

Subsequently, the control apparatus 10 controls ON/OFF of the LED 17 according to whether or not the amount of outdoor light is not less than the threshold value Z1 (Step 54).

At this time, in the case where the light amount of the cultivation surface 12a falls below the target accumulated light amount (cumulative value) in N hours, the control apparatus 10 turns on the LED 17 regardless of the light amount Z of outdoor light. Further, in the case where the total amount of the light amount (sunlight) of the cultivation surface 12a and the light amount (artificial light) of the LED 17 exceeds the light saturation point (e.g., 400 μmol/m2·s in the case of lettuce) of the seedling V, the control apparatus 10 turns off the LED 17.

Subsequently, the control apparatus 10 multiplies the light amount of the cultivation surface 12a by the ON hours of the LED 17 to calculate results of the accumulated light amount of one hour (Step 55).

Subsequently, the control apparatus 10 determines whether the target accumulated light amount of one hour is insufficient in the above-mentioned results (Step 56).

In the case where it is determined that the target accumulated light amount is insufficient (Yes), the control apparatus 10 adds the deficiency to the target accumulated light amount of the next one hour (Step 57).

Meanwhile, in the case where it is determined that the target accumulated light amount is exceeded (No), the control apparatus 10 subtracts the excess amount from the target light amount of the next one hour (step 58).

Subsequently, the control apparatus 10 determines whether or not the control in the N-th hour is completed (Step 59), and repeatedly executes the processing of Steps 52 to 56 as long as the control of the N-th hour is not completed.

Then, in the case where it is determined that the control in the N-th hour is completed (Yes), the control apparatus 10 calculates the shortage of the light amount of the cultivation surface 12a by subtracting the result value after N hours from the target accumulated light amount of one day (Step 60).

Subsequently, the control apparatus 10 sets the light supplement conditions (irradiation time and irradiation time zone) by the LED 17 for the above-mentioned deficiency (Step 61). Specifically, the control apparatus 10 calculates the irradiation time by dividing the light amount of the deficiency by the light amount of the LED 17 per unit time at the time of maximum output, and sets the irradiation time zone to, for example, any of a time zone immediately after the N-hour irradiation or the nighttime.

Then, the control apparatus 10 completes the light adjusting control processing of one day by executing light supplement by the LED 17 according to the set light supplement conditions described above, and starts the light adjusting control processing of the next day (Step 62).

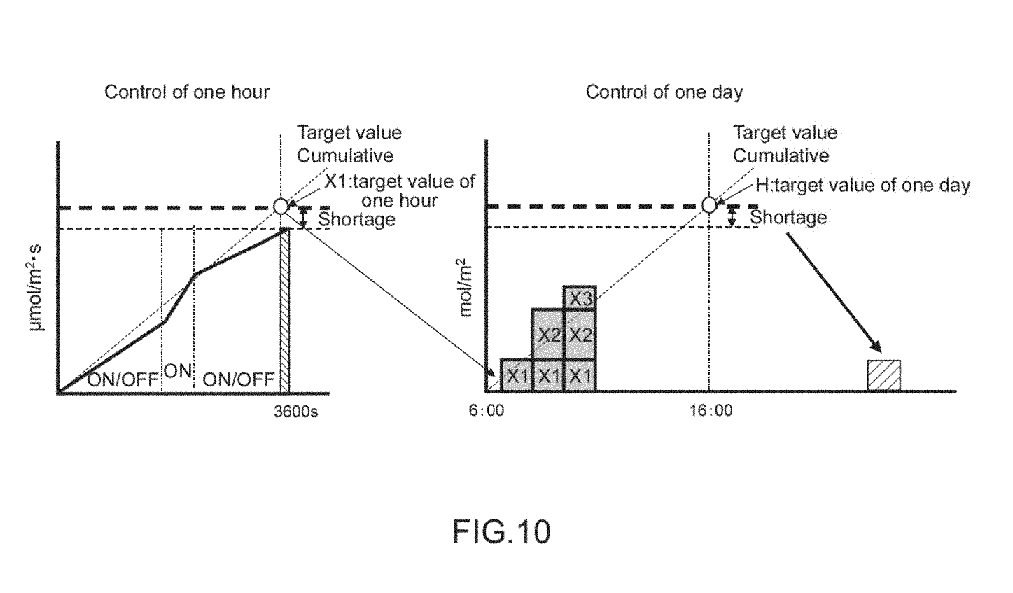

FIG. 10 is a diagram showing the relationship between the light adjusting control processing (left side in the figure) of one hour and the light adjusting control processing of one day (right side in the figure).

As shown on the left side of the figure, in the case where the accumulated light amount of the cultivation surface 12a falls below the target accumulated light amount (shown by the broken line in the figure) in a certain one hour, the control apparatus 10 forcibly turns ON the LED 17 regardless of the light amount Z of outdoor light.

Further, in the case where a shortage occurs in the target accumulated light amount in a certain 1 hour (X1), the control apparatus 10 adds the shortage to the target accumulated light amount of the next one hour (X2). On the contrary, in the case where an excess amount from the target accumulated light amount occurs in a certain one hour, the control apparatus 10 adds the excess amount to the accumulated light amount of the next one hour to perform control so that the accumulated light amount of the cultivation surface 12a reaches the target accumulated light amount in each hour.

However, as shown on the right side of the figure, in the case where a shortage occurs in the target accumulated light amount H of one day by the control for each hour, the control apparatus 10 determines the irradiation time and the irradiation time zone of light supplement by the LED 17 according to the shortage to execute light supplement, as described above.

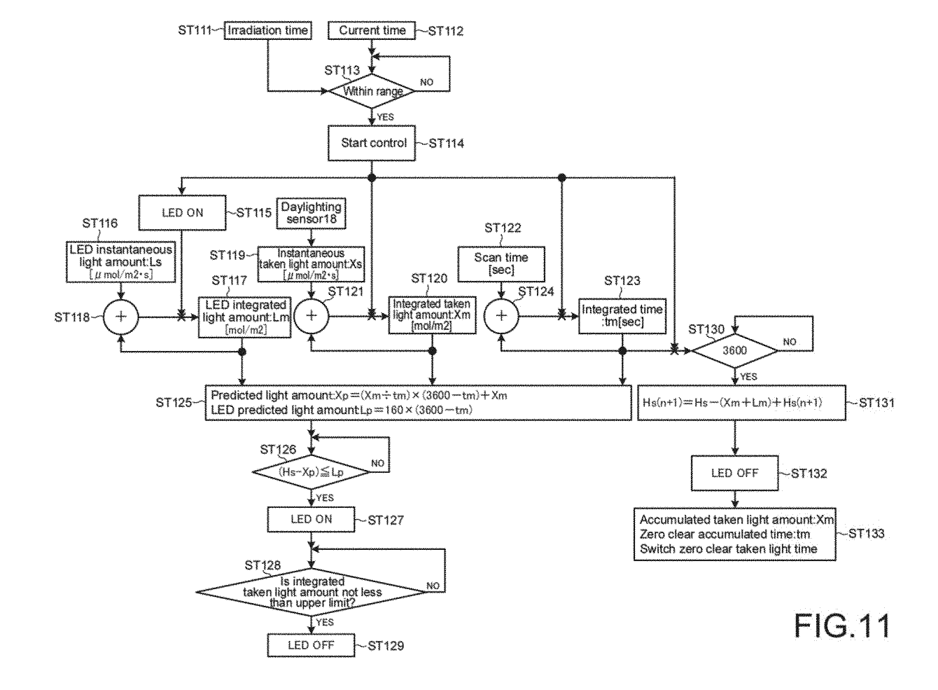

FIG. 11 is a flowchart showing further detailed flow of the light adjusting control processing of the LED 17 by the ON/OFF control+accumulated amount control.

In the figure, Hs, Xs, Xm, Xp, Ls, Lp, and Lm respectively represent the target accumulated light amount of one hour, the instantaneous light amount of sunlight to be applied to the cultivation surface 12a, the accumulated taken light amount of the sunlight, the predicted accumulated light amount of the sunlight expected to be applied to the cultivation surface 12a in the remaining time from the present time in the one hour, the instantaneous light amount of artificial light from the LED 17 to be applied to the cultivation surface 12a, the predicted accumulated light amount of the artificial light expected to be applied to the cultivation surface 12a in the remaining time from the present time in the one hour, and the accumulated light amount of the artificial light.

Further, in the figure, the light adjusting control processing at night for the insufficient amount caused by the light adjusting control processing during the day is not included.

As shown in the figure, the control apparatus 10 inputs a setting value of the irradiation time (time zone) of sunlight of one day and the current time (Steps 111, 112), and determines whether or not the current time is within the irradiation time (Step 113).

In the case where it is determined that the current time is within the irradiation time (Yes), the control apparatus 10 starts the light adjusting control processing (Step 114).

Upon start of the light adjusting control processing, the control apparatus 10 executes processing of integrating the light amount of the LED 17, processing of integrating the light amount of sunlight, and processing of controlling light adjusting time in parallel.

In the processing of integrating the light amount of the LED 17, the control apparatus 10 turns ON the LED 17 first (Step 115).

Subsequently, the control apparatus 10 sequentially calculates the instantaneous light amount Ls of the cultivation surface 12a (Step 116) on the basis of the instantaneous light amount sequentially input from the LED 17, and adds it to the previous accumulated light amount Lm of the LED 17 (Steps 117, 118).

Further, in the processing of integrating the light amount of sunlight, the control apparatus 10 sequentially calculates the instantaneous light amount Xs of the cultivation surface 12a on the basis of the instantaneous light amount of the light emitting surface 15a sequentially input from the daylighting sensor 18 (Step 119), and adds it to the previous accumulated taken light amount Xm of sunlight (Steps 120, 121).

Further, in the processing of controlling light adjusting time, the control apparatus 10 sequentially inputs the scan time from a timer (Step 122), and adds it to the previous accumulated time tm (Steps 123, 124).

Subsequently, the control apparatus 10 calculates, on the basis of the accumulated taken light amount Xm of sunlight and the accumulated time tm, the predicted light amount Xp of sunlight expected to be applied in the remaining time from that point in the one hour by the following formula (Step 125).

Predicted light amount: Xp=(Xm/tm)×(3600−tm)+Xm

In addition, the control apparatus 10 calculates, on the basis of the accumulated light amount Lm of the LED 17 and the accumulated time, the predicted light amount Lp of artificial light expected to be applied in the remaining time from that point in the one hour by the following formula (Step 125).

LED predicted light amount:Lp=160(3600−tm)

Subsequently, the control apparatus 10 determines whether or not the value (Hs−Xp) obtained by subtracting the predicted light amount Xp of sunlight from the target accumulated light amount Hs in the one hour is smaller than the predicted light amount Lp of artificial light (Step 126).

In the case where it is determined that the (Hs−Xp) is smaller than Lp (Yes), the control apparatus 10 turns ON the LED 17 (Step 127). In the case where the LED 17 is already ON, the ON state is continued.

Further, the control apparatus 10 determines whether or not the total amount of the instantaneous light amount Xs of sunlight and the instantaneous light amount Ls of artificial light is not less than the upper limit (light saturation point of the seedling V) (Step 128), and turns OFF LED17/the LED 17 (Step 129) in the case where it is determined that the total amount is not less than the upper limit (Yes).

Further, in parallel with the above-mentioned ON/OFF control of the LED 17, the control apparatus 10 determines whether or not the one hour of the processing target has passed (Step 130).

In the case where it is determined that the one hour has passed (Yes), the control apparatus 10 adds, as a correction amount, the value obtained by subtracting the sum (Xm+Lm) of the accumulated light amount of sunlight and artificial light from the target accumulated light amount Hs to the target accumulated light amount Hs (n+1) in the next target hour, and sets the target accumulated light amount Hs (n+1) of the next hour (Step 131). Note that the control apparatus 10 may switch the processing at the current time without waiting for one hour to pass depending on the situation.

Then, the control apparatus 10 turns OFF the LED 17 (Step 132), clears the accumulated taken light amount Xm of sunlight and the accumulated time tm to zero, and switches the processing to that of the next hour (Step 133).

The control apparatus 10 executes the above-mentioned processing until the set irradiation time has passed.

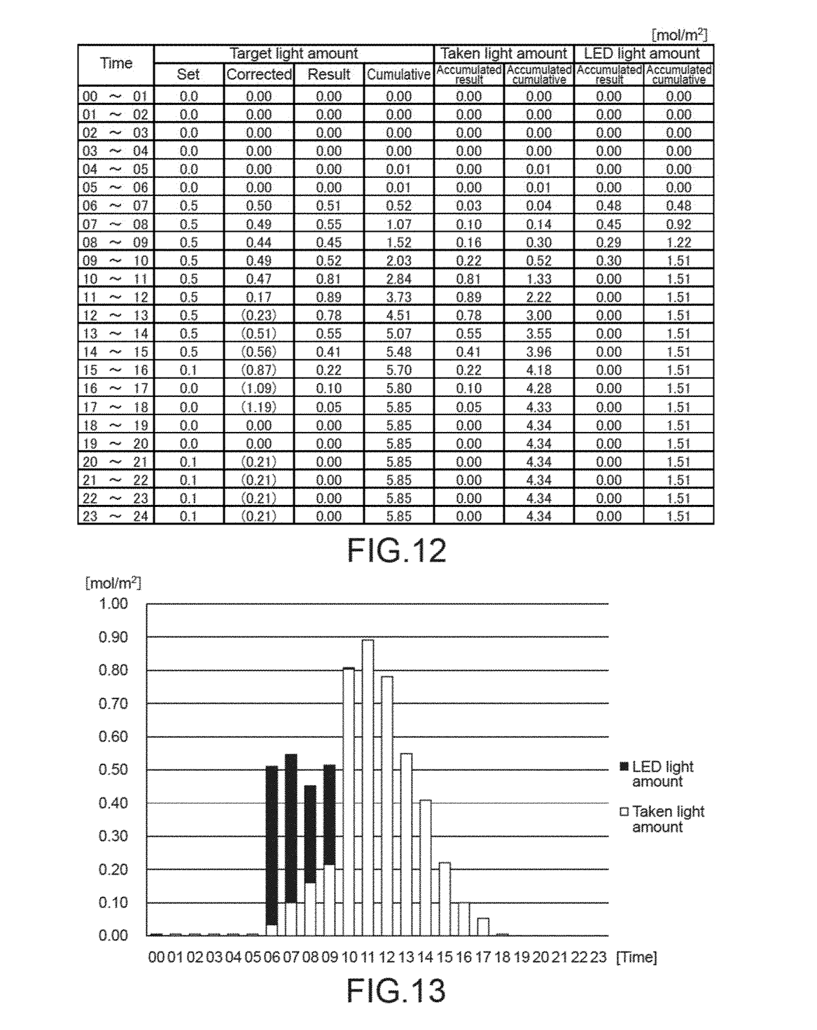

FIG. 12 is a table showing the result of performing the light adjusting control processing of the LED 17 by the ON/OFF control+accumulated amount control shown in FIG. 11, and FIG. 13 is a graph showing the one day result of performing the light adjusting control processing.

As shown in both figures, application of sunlight, which is taken by the daylighting apparatus 13, from the light emitting surface 15a to the cultivation surface 12a is started from 6 a.m., and also application of the LED 17 to the cultivation surface 12a is started. Both of them are performed until 6 p.m.

Note that the target accumulated light amount for one day was set to 5 mol/m2, and the light amount of the LED 17 at the time of sunlight application was set to 160 μmol/m2·s.

From the table shown in FIG. 12, also as shown in FIG. 11, it can be seen that in the case where the accumulated light amount in a certain one hour is insufficient, the shortage is added as a correction value of the target accumulated light amount in the next one hour, and in the case where the accumulated light amount in a certain one hour is exceeded, the excess amount is subtracted as a correction value of the target accumulated light amount in the next one hour.

Further, in the nighttime (21:00 to 23:00) after taking light in the daytime, the average value of the accumulated light amount corresponding to the shortage of the accumulated light amount in the daytime is added as the target accumulated light amount Hs for each hour at night, and light supplement by the LED 17 is performed.

Note that the target accumulated light amount for each hour at night needs to be within 70% of the light amount of the LED 17 when the LED 17 is continuously energized.

As described above, in the daytime, the control apparatus 10 is capable of dynamically controlling ON/OFF of the LED 17 in each processing target hour on the basis of the predicted value of the light amount of the cultivation surface 12a, and adding the deficiency of the target accumulated light amount of each hour to the target accumulated light amount in the next one hour to perform light adjustment. In addition, the control apparatus 10 is capable of compensate for the shortage of the accumulated light amount in the daytime with respect to the target accumulated light amount of one day by light supplement by the LED 17 at night.

[Processing of Managing Growth of Seedling]

In this embodiment, the control apparatus 10 is capable of executing not only various kinds of light adjusting control processing described above but also processing of managing the growth of the seedling V using the daylighting sensor 18. Hereinafter, details of this growth management processing will be described.

In general, the reflectance of the cultivation surface 12a is reduced as the leaf area of a plant is increased (that is, the seedling grows). It is considered that this is because the rate at which the leaves absorb artificial light applied from the LED 17 is increase as the leaf area is increased.

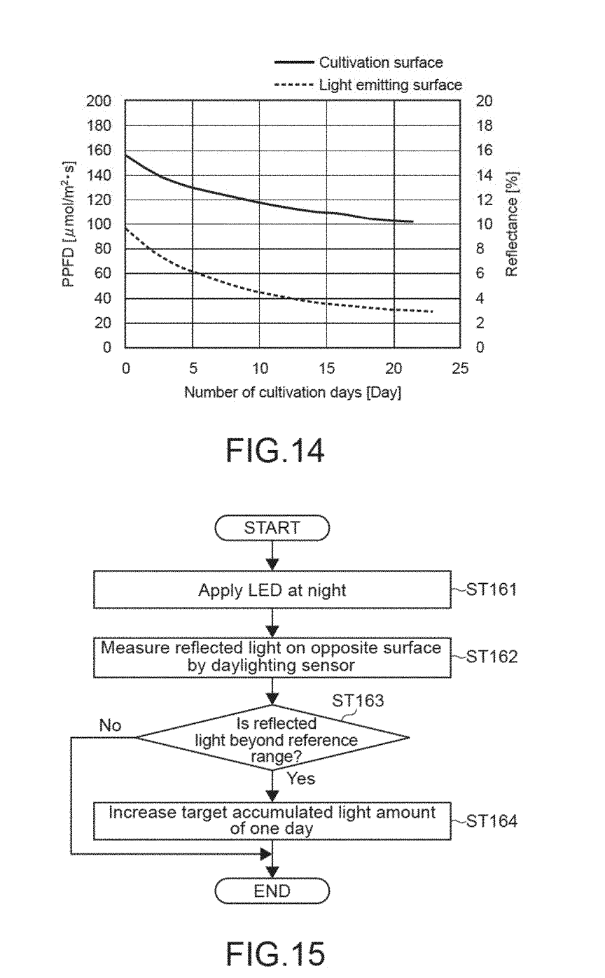

FIG. 14 is a graph showing the relationship between the light amount of artificial light applied from the LED 17 on the cultivation surface 12a and the light emitting surface 15a and the number of cultivation days of the seedling V. Note that the figure shows values in the case where the output of the LED 17 is set to 50%.

As shown in the figure, it can be seen that the light amount of the light emitting surface 15a as well as the cultivation surface 12a is reduced as the cultivation days pass (that is, leaves of the seedling V grow). It is considered that this is because reflected light the cultivation panel 12 or the acrylic plates 15, which is artificial light applied from the LED 17, is reduced by the growth of the leaves. Therefore, it is considered that the necessary supplemental light amount by the LED 17 is larger as the leaves grow.

In this regard, in this embodiment, the control apparatus 10 has a mechanism for applying a certain amount of the LED 17 in a time zone (nighttime) in which there is no sunlight using the daylighting sensor 18, determining whether or not the amount of reflected light at each growth period of the seedling V is secured by measuring reflected light from the cultivation surface 12a, and thereby adjusting the output of the LED 17.

That is, the control apparatus 10 is capable of utilizing the positional relationship that the cultivation panels 12 are provided opposite to each other in the horizontal direction with the pair of light emitting surface 15a facing in the horizontal direction disposed therebetween to use the daylighting sensor 18 installed on one of the light emitting surfaces 15a for detecting the application amount of sunlight to be applied to the seedling V of the cultivation panel facing the light emitting surface 15a as well as reflected light of artificial light to be applied from the LED 17 of the light emitting surface 15a opposed to that light emitting surface 15a to the seedling V of the cultivation panel facing the light emitting surface 15a, thereby executing the processing of managing the growth of the seedling V.

FIG. 15 is a flowchart showing flow of the growth management processing using the reflected light amount of leaves. When executing the processing, the control apparatus 10 holds, in the storage unit 8, the reference data regarding the reflectance (reflected light amount) corresponding to the number of cultivation days of the leaves.

As shown in the figure, in a time zone (nighttime, or the like) in which there is no sunlight, the control apparatus 10 applies artificial light from the LED 17 to the cultivation panel 12 facing the light emitting surface 15a (acrylic plates 15) on which the same LED 17 is provided (Step 161). This application of artificial light may be executed as the light supplement processing by the LED 17 in the light adjusting control processing, or may be executed separately therefrom.

Subsequently, the control apparatus 10 acquires a measurement value of the reflected light amount of the applied artificial light by the daylighting sensor 18 provided on the light emitting surface 15a (acrylic plates 15) facing the light emitting surface 15a (acrylic plates 15) on which the same LED 17 is provided (Step 162).

Subsequently, the control apparatus 10 determines whether or not the measurement value of the reflected light is within a predetermined range in accordance with the above-mentioned reference data (Step 163). For example, assuming that the reflected light amount on the x-th day in the reference data is 50 μmol/m2·s, in the case where the measured reflected light amount is within ±5% thereof, it is determined to be within the reference range, otherwise, it is determined to be beyond the reference range.

In the case where it is determined that the measured reflected light amount is beyond the reference range, then, the control apparatus 10 increases the target accumulated light amount of one day of artificial light to be applied by the LED 17 by a predetermined ratio (e.g., 10%) (Step 164).

Accordingly, the control apparatus 10 is capable of grasping the growth degree of the seedling V on the basis of the reflected light amount from the seedling V, and managing the growth of the seedling V by increasing the application amount of artificial light from the LED 17 in the case where it is determined that the seedling V is not properly growing.

[Conclusion]

As described above, according to this embodiment, a hydroponic cultivation system is capable of suppressing the variations in the growth of the seedling V in the case of performing cultivation with only sunlight, thereby to perform stable production by controlling, on the basis of the light amount (value predicted from the light amount of the light emitting surface 15a) of sunlight to be applied to the cultivation surface 12a, the application amount of artificial light to be applied from the LED 17, and reducing the power cost for applying artificial light by applying, as necessary, artificial light.

### MODIFIED EXAMPLES

The present invention is not limited to the above-mentioned embodiment, and various modifications can be made without departing from the essence of the present invention.

In the above-mentioned embodiment, the control apparatus 10 may compare the change in the light amount of sunlight detected by the daylighting sensor 18 and the change in the light amount of sunlight detected by the outdoor light sensor 19, and output, in the case where it is determined that there is no correlation between them, information representing abnormality.

That is, the control apparatus 10 is capable of improving the precision of the light adjusting control processing by outputting abnormality information in the case where it is detected that the amount of light of the light emitting surface 15a, which is normally correlated with the amount of outdoor light, is not correlated with the amount of outdoor light. Here, as a cause for losing the correlation between the above-mentioned changes, for example, a situation in which the daylighting sensor 18 is irradiated with direct light or hidden behind the seedling V or human to reduce the taken light amount is assumed. Upon receiving the abnormality information, a user of the hydroponic cultivation system is capable of taking measures such as adjusting the position of the daylighting sensor 18.

Further, in the case where the above-mentioned abnormality is detected, the control apparatus 10 may analyze the output from each daylighting sensor 18, specify the daylighting sensor 18 outputting the abnormality value, and automatically control the output from the specified daylighting sensor 18 so as not to be used for the light adjusting control processing for at least a certain time period.

In the above-mentioned embodiment, the LED 17 has been used as the artificial light application apparatus. However, the artificial light application apparatus is not limited thereto, and a fluorescent lamp, an organic light emitting diode (OLED), or the like may be used, for example.

In the above-mentioned embodiment, the light adjusting control processing has been executed in units of one hour and one day. However, the control unit is not limited thereto, and may be appropriately changed.

In the above-mentioned embodiment, the light emitting surface 15a has been provided as each outer surface of the pair of acrylic plates 15. However, the light emitting surface 15a does not necessarily need to be provided on an acrylic plate, and may be provided on any of members constituting the daylighting apparatus 13.

In the above-mentioned embodiment, an example in which the control apparatus 10 is placed in the same place (plant factory) as the place where the hydroponic cultivation unit 11 is placed has been shown. However, the control apparatus 10 may be placed at a position apart from the plant factory, and may be provided as a server on the Internet (cloud). In this case, in the plant factory, a control panel or a computer for relaying exchange of the detection value of the daylighting sensor 19, the output value of the LED 17, or data necessary for the light adjusting control processing such as an ON/OFF command with the control apparatus 10 on the Internet may be provided.

### REFERENCE SIGNS LIST

1 CPU
8 storage unit
9 communication unit
10 control apparatus
11 hydroponic cultivation unit
12 cultivation panel
12a cultivation surface
13 daylighting apparatus
14 daylighting port
15 acrylic plate
15a light emitting surface
16 diffusion plate
17 LED
18 daylighting sensor
19 outdoor light sensor
100 hydroponic cultivation system
L liquid fertilizer
V seedling

1. A hydroponic cultivation system, comprising:
a hydroponic cultivation unit including a seedbed, a seedling of a plant to be cultivated being transplanted to the seedbed;
a daylighting apparatus that takes natural light through a daylighting port into a light emitting surface facing the seedbed, and emits the light from the light emitting surface toward the seedling;
an artificial light application apparatus that applies artificial light to the seedling;
a daylighting sensor that is provided at a position apart from the seedbed, and detects a light amount of the natural light emitted from the light emitting surface; and
a control apparatus that calculates, on a basis of the detected light amount, a predicted value of a light amount of the natural light to be applied to a cultivation surface of the seedling in the seedbed, and controls, on a basis of the predicted value, an application amount of the artificial light.

2. The hydroponic cultivation system according to claim 1, wherein
the control apparatus controls the application amount of the artificial light of a predetermined time period so that a sum of the application amount of the artificial light and an accumulated value of the predicted value of the predetermined time period reaches a predetermined target instantaneous light amount.

3. The hydroponic cultivation system according to claim 1, wherein
the daylighting sensor is provided on the light emitting surface.

4. The hydroponic cultivation system according to claim 3, wherein
the artificial light application apparatus is provided on the light emitting surface, and
the daylighting sensor is provided at a position where the daylighting sensor is not affected by the artificial light of the light emitting surface.

5. The hydroponic cultivation system according to claim 4, wherein
the seedbed includes seedbeds provided to face each other in a horizontal direction with a pair of light emitting surfaces disposed between the seedbeds, the pair of light emitting surfaces being provided opposite to each other in the horizontal direction,
the daylighting sensor is capable of detecting, at a time when the natural light is not applied, a light amount of reflected light of artificial light applied, to the seedling, from the artificial light application apparatus provided on the light emitting surface facing the light emitting surface on which the same daylighting sensor is provided, and
the control apparatus controls the application amount of the artificial light on a basis of a change in the detected light amount of reflected light.

6. The hydroponic cultivation system according to claim 1, further comprising
an outdoor light sensor that detects a light amount of outdoor natural light, wherein
the control apparatus outputs information representing abnormality in a case where it is determined that there is no correlation between a change in a light amount of natural light detected by the daylighting sensor and a change in a light amount of natural light detected by the outdoor light sensor.

7. A hydroponic cultivation system, comprising:
a hydroponic cultivation unit including a seedbed, a seedling of a plant to be cultivated being transplanted to the seedbed;
a daylighting apparatus that takes natural light through a daylighting port into a light emitting surface facing the seedbed, and emits the light from the light emitting surface toward the seedling;
an artificial light application apparatus that applies artificial light to the seedling; and
a daylighting sensor that is provided at a position where the daylighting sensor is not affected by the artificial light of the light emitting surface, and detects, for controlling an application amount of the artificial light, a light amount of the natural light emitted from the light emitting surface.

8. A hydroponic cultivation control apparatus, comprising:
a reception unit that receives, from a daylighting sensor provided at a position apart from a seedbed, a detection value of a light amount of natural light taken through a daylighting port into a light emitting surface facing the seedbed, the natural light being emitted from the light emitting surface, a seedling of a plant to be cultivated being transplanted to the seedbed; and
a control apparatus that calculates, on a basis of the received detection value, a predicted value of a light amount of the natural light to be applied to a cultivation surface of the seedling in the seedbed, and controls, on a basis of the predicted value, an application amount of the artificial light to be applied to the seedling.

9. A hydroponic cultivation method, comprising:
placing a seedbed in a hydroponic cultivation unit, a seedling of a plant to be cultivated being transplanted to the seedbed;
taking natural light from outside into a light emitting surface facing the seedbed, and applying the light from the light emitting surface toward the seedling;
calculating, on a basis of a light amount of the natural light to be output from the light emitting surface, which is detected by a daylighting sensor that is provided at a position apart from the seedbed, a predicted value of the light amount of the natural light to be applied to a cultivation surface of the seedling in the seedbed; and
controlling, on a basis of the predicted value, an application amount of the artificial light to be applied to the seedling.

10. A program that causes a hydroponic cultivation control apparatus to execute the steps of:
receiving, from a daylighting sensor provided at a position apart from a seedbed, a detection value of a light amount of natural light taken through a daylighting port into a light emitting surface facing the seedbed, the natural light being emitted from the light emitting surface, a seedling of a plant to be cultivated being transplanted to the seedbed;
calculating, on a basis of the received detection value, a predicted value of a light amount of the natural light to be applied to a cultivation surface of the seedling in the seedbed; and
controlling, on a basis of the predicted value, an application amount of the artificial light to be applied to the seedling.
